(19) United States
(12) Patent Application Publication
(10) Pub. No.: US 2008/0249730 A1
(43) Pub. Date: Oct. 9, 2008

(54) System and Method For Determining Characteristics of a Moving Material by Using Microwaves

(75) Inventors: Erling Svensson, Hyltebruk (SE); Harald Merkel, Lindome (SE)

Correspondence Address: BIRCH STEWART KOLASCH & BIRCH, PO BOX 747, FALLS CHURCH, VA, 22040-0747, US

(73) Assignee: Kambo Skans AB, Hyltebruk (SE)

(21) Appl. No.: 11/885,057

(22) PCT Filed: Feb. 24, 2006
(86) PCT No.: PCT/SE06/00249

§ 371 Date: Nov. 6, 2007

(30) Foreign Application Priority Data
Feb. 24, 2005 (SE) 0500424-7

(51) Int. Cl. G01N 37/00

(52) U.S. Cl. 702/84

(57) ABSTRACT

The present invention is related to a system for determining characteristics of a material. The system comprises means for sending and measuring microwave radiation, whereby the microwave radiation is used for determining the characteristics of the material 90. The invention is also related to such a method.

### FIELD OF THE INVENTION

The present invention is related to the field of production supervision, and in particular to an improved system for the detection of features of a material, as claimed in claim 1. The present invention is also related to a method as claimed in claim 18.

### BACKGROUND OF THE INVENTION

There are tight set quality requirements within widely differing fields of manufacturing. The fulfilment of these requirements is important and is thus supervised in various ways, which is why different kinds of quality controls are frequently used to ensure the quality of a specific product. It is, for example, possible to use visible and infrared radiation for this purpose, and vision systems are available for use in quality controls. These vision systems are however very expensive, and not well suited for certain applications.

However, in the plastic bag manufacturing industry of today, there is no efficient automated quality control of properties of a material, such as for example the weldings and perforations of a plastic film used for manufacturing plastic bags. The quality of the weldings and perforations needed are simply manually controlled by inflation and destruction of statistically selected plastic bags. Obviously, this is a very uneconomic, time consuming and incomplete supervision method, requiring both labour time and entailing a waste of products.

Further, in order to properly wrap a certain number of plastic bags for selling, they have to be counted. Presently, the bags are counted by using high voltage spark gaps. Such spark gaps are operated at unacceptable voltage levels and are therefore not suitable for environments where large amounts of easily inflammable products are stored and handled. Further, the margin of profit in the manufacturing of plastic bags is rather limited, and a miscalculation of even a relatively small number of plastic bags is thus crucial for the yield of a production line.

Furthermore, the above mentioned method of using visible and infrared radiation is not applicable to arbitrarily coloured plastic films or to plastic material not imposing any measurable photon losses (e.g. transparent, thin (PE)), since the local absorption of an incident signal is measured using photometers. In addition, the optical quality of weldings and perforation signature is poor, thus further rendering such quality controls difficult.

Thus, what is needed is a system and method for improving and automatizing the supervision of properties of various materials, such as plastic bags and the like. Further, it would be desirable to provide a system and method enabling an accurate counting of plastic bags or similar items, in an easy and economic, yet reliable way.

### SUMMARY OF THE INVENTION

It is an object of the present invention to provide a system for enabling detection and supervision of the properties of different, optional materials, in which the above described drawbacks are eliminated. More specifically it is an object of the present invention to provide an easy to implement and easy to use system for supervising materials used in production, not involving any hazardous components or steps.

In accordance with the present invention, a system for determining characteristics of a material is provided. The system comprises means for continuously acquiring at least one reference value, and means for acquiring at least one measurement value, whereby the reference value(s) and the measurement value(s) are being acquired and compared in real-time. Thereby characteristics of any material may be determined in an easily implemented way. The at least one reference value is obtained simultaneously as the material is being tested, i.e. simultaneously as the measurement values are being obtained.

These objects are achieved, according to a first aspect of the invention, by a system as defined in claim 1, and a method as claimed in claim 18.

In accordance with one embodiment of the invention, the system comprises means for utilizing microwave radiation in order to determine characteristics of the material. More specifically, the system comprises means for generating, sending and measuring microwave radiation, whereby the microwave radiation is used in determining desired characteristics of a material.

In accordance with one embodiment of the present invention the means for sending and measuring microwave radiation comprises means for measuring a microwave transmission factor S21 between two ports, between which ports the material is arranged to run. This embodiment may be implemented using different kinds of ports, such as antennas or inductors or the like. Thereby the invention may be realised by components readily available on the market, and also giving a great design flexibility for providing application specific solutions.

In accordance with another embodiment of the present invention the means for measuring comprises means for calculating the ratio between power received by one of said ports and power emitted by the other of said ports.

In accordance with another embodiment of the present invention the thickness d of a material is determined by calibration data, and the following equations:

$$\begin{matrix}{k}_{0} = ω \cdot \sqrt{{ɛ}_{0} \cdot {μ}_{0}} & [ 1 ] \\ k = ω \cdot \sqrt{{ɛ}_{r} \cdot {ɛ}_{0} \cdot {μ}_{r} \cdot {μ}_{0}} & [ 2 ] \\ {S}_{21} = {e}^{= i kd } \cdot {e}^{- i {k}_{0} ( D - d )} & [ 3 ] \\ d = \frac{{k}_{0} D - i \cdot log {S}_{21}}{( k - {k}_{0} )} & [ 4 ]\end{matrix}$$

where ε=dielectric constant of the material, ε₀=dielectric constant of vacuum, k=wave vector in the material, k₀=wave vector in vacuum, μ=permeability and μ₀=permeability of vacuum, d=thickness of the material, D=the distance between included transmit and the receive ports. Thereby explicit expressions are provided, enabling an easy implementation of the present invention.

In accordance with another embodiment of the present invention means for sending and measuring microwave radiation comprises at least two oscillators, and at least two independent measurement zones coupled to the oscillators, which provides a reliable and yet inexpensive way to supervise the quality of a material.

In accordance with another embodiment of the present invention each measurement zone comprises capacitor plates, or inductors or antenna elements determining an oscillation frequency of an oscillator in the microwave range. This embodiment again provides a solution with great flexibility and components readily available and easy to replace in embodiments where the components are not fastened in a non-removable way. Further, the capacitor plates may be placed on the same side of a material being tested, which is very advantageous in environments and applications that are space limited.

In accordance with another embodiment of the present invention means are included for measuring the oscillation frequency of an oscillator circuit. The oscillation frequency contains information of the properties of the material.

In accordance with another embodiment of the present invention said characteristics comprise one of more of the following: the thickness of the material, the dielectric loss of the material, perforations, markings or the like in the material, welding in the material, the material constituting a single sheet of material or multiple, or multiple folded. A user may thus measure a wide range of properties, chosen suitably for the application in question.

The present invention further provides such a method, whereby advantages similar to the above described are achieved.

### BRIEF DESCRIPTION OF THE DRAWINGS

FIG. 1 shows the sensor arrangement in accordance with the present invention.

FIG. 2 shows an electronic apparatus comprising the present invention.

FIG. 3 shows an exemplary geometry of capacitor pads used in accordance with the present invention.

FIG. 4 shows timing diagrams of a measurement result in accordance with the present invention.

FIGS. 5a-5c show an alternative embodiment of the present invention.

### DETAILED DESCRIPTION OF PREFERRED EMBODIMENTS

The inventor of the present invention has realised the possibility to use electromagnetic radiation in the microwave range of the radio frequency spectrum for supervision and detection applications, for example for quality control purposes, and/or in order to detect certain features of an optional material, used preferably in an assembly line production.

In order to facilitate the understanding of the present invention, a brief description of microwave transmission is given in the following.

A microwave transmission method in accordance with the invention may be used in a number of technologies, e.g. for the measurement of water contents in stone, crops, cotton and pulp. The method relies on the measurement of the so called microwave transmission factor between two ports referred to as S21, as is known to a person skilled in the art. These two ports are implemented as antennas in all suitable technologies, and it is assumed in this description that the ports are antennas, if not stated otherwise in a specific embodiment. The transmission information is related to the object being tested, said object being placed between the two antennas. Under certain conditions the two antennas can be combined to a single antenna using directional couplers, as is known within the art.

There are two distinct ways to evaluate the microwave properties in accordance with the invention: frequency domain measurement and time domain measurement, respectively, both of which will be described below.

Frequency domain measurement: an S₂₁ parameter measurement involves the calculation of the ratio between the power received by the receive antenna and the power emitted by the transmit antenna. In order to calculate the power emitted by the transmit antenna one has to measure the power transmitted to the receive antenna and the power reflected back to the generator in at least three reference cases for a complete characterization of the transmit antenna.

Time domain measurement: sharp, short microwave pulses are emitted and transmitted through the measurement gap. The measurement method is based on comparing the signal runtime through the measurement gap with the runtime through a reference line with eventually adjustable length. In implementing the present invention suitable reference cases for a frequency domain measurement comprises: 1) no material present in the measurement gap, 2) completely blocked measurement gap (the blocking being accomplished for example by means of a metal sheet), and 3) measurement gap filled by an absorber.

With calibration data, the S21 parameter may be calculated between the antennas. From this in turn, the thickness of the material being placed in the measurement gap is deduced according to:

k₀=ω·\sqrt{ε₀·μ₀} [1]

k=ω·\sqrt{εᵣ·ε₀μᵣμ} [2]

S₂₁=e^{-ikd}·e^{-ik}^{₀}^{(D-d)} [3]

where ε=dielectric constant of the material, ε₀=dielectric constant of vacuum, k=wave vector in the material, k₀=wave vector in vacuum, μ=permeability and μ₀=permeability of vacuum, all using SI units. The thickness of the material is denoted d, the distance between the transmit and the receive antenna is denoted D. The imaginary unit is referred to as i and the angular frequency is given by 2π times the RF frequency. Converting the S parameter to the wave vector in the gap and by assuming the wave vector of the material to be known (since its dielectric and magnetic properties are known), its thickness may be calculated as:

$$d = \frac{{k}_{0} D - i \cdot log {S}_{21}}{( k - {k}_{0} )} \qquad [ 4 ]$$

Obviously, this method may be used only when there is a difference in the k vector between vacuum and the material being tested.

As is known within the field, there are several ways to measure the S₂₁ parameters within a small frequency range, such as CW (continuous wave) radar and FMCW (frequency modulation continuous wave) radar.

Also, obviously the obtained thickness is averaged over the measurement zone and reflects the effective thickness, e.g. perforation with 50% cut out material will be reflected in a thickness variation down to

$${d}_{min} \approx \frac{1}{2} d .$$

The obtained thickness is therefore an effective thickness. Similar reasoning apply to changes in the dielectric function, a peak of ε will be detected as a peak in thickness when assuming ε to be constant.

The present invention may be implemented utilizing a time domain measurement, the theory of which is given in the following.

The signal runtime through a measurement gap is given by the following relation:

T=ν₀(D−d)+ν·d [5]

where v=group velocity of the microwave pulse in the material, and v₀=group velocity of the microwave pulse in vacuum. T denotes the time required by a microwave pulse to traverse the measurement gap. Obviously, this method may be used only if there is a difference in group velocity between vacuum and the material.

The fundamental issue when comparing equations [3] and [5] is how to calculate the group velocity and how to relate it to the dielectric and magnetic properties of different materials. In an ideal case, the microwave pulse is infinitely short, which corresponds to an infinitely broadband frequency pulse. In reality however, the electronics used have rise times, and the transmit and receive antenna bandwidth will limit the frequency spectrum of the transmitted pulse to a spectrum that can be approximated by a Gaussian curve centred around a value ω₀ and having a spectral width given by σ. For reasonably small dependencies of the dielectric properties on frequency, the group velocity of the pulse is readily obtained as:

$$v = \frac{\partial k}{\partial ω} {\vert}_{ω = {ω}_{0}} = \sqrt{{ɛ}_{r} \cdot {ɛ}_{0} \cdot {μ}_{r} \cdot {μ}_{0}}$$

$${v}_{0} = \frac{\partial {k}_{0}}{\partial ω} {\vert}_{ω = {ω}_{0}} = \sqrt{{ɛ}_{0} \cdot {μ}_{0}}$$

Using this approximation, equations [3] and [5] become identical.

In another embodiment of the present invention, the properties of a material being tested are not measured using transmitted or reflected microwave radiation. Instead, the properties of the material (or product) are used in an oscillator circuit, the frequency of oscillation of which is measured. The oscillation frequency and the oscillation signal then contain information about the microwave properties of the material. This method does not utilize microwave antennas; the microwave interaction is instead communicated via suitably mounted capacitor plates.

The information obtained of the properties of the material could be used to control different operations, such as adjusting the power of the welding device to optimize the power needed to create a good weld. Another operation that could be controlled is the extraction process, which can be adjusted to obtain a more or less constant thickness of the extruded material. The information could even be used to detect the presence of a material at a specific location to initiate some kind of action, e.g. cutting a straw in the right length after extrusion.

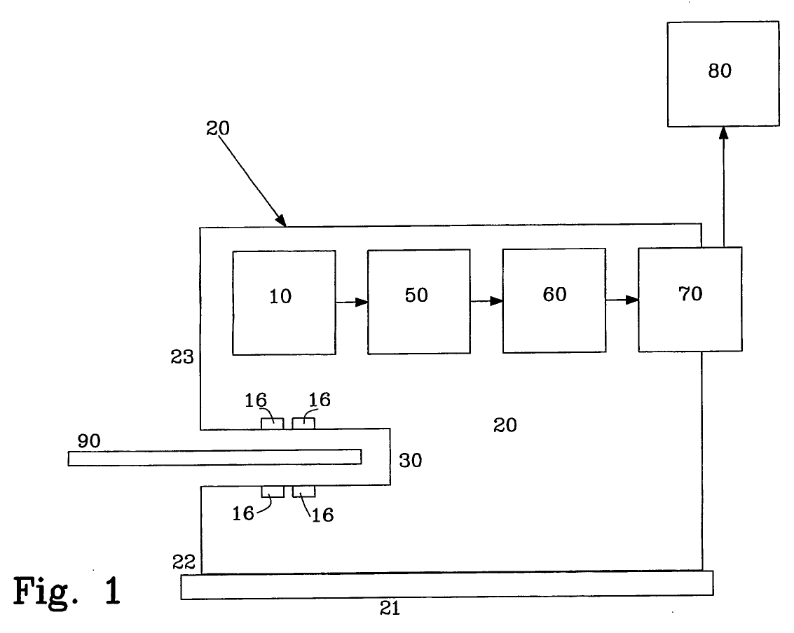

Based on the theory given above, an implementation of the present invention will now be described, firstly with reference to FIG. 1.

The sensor used in accordance with the present invention consists of an electronic apparatus 10 mounted in an arrangement 20, as shown in FIG. 1. The shown setup allows a product 90, that is being tested, to be transferred through a measurement gap 30. The arrangement 20 may for example be positioned in the vicinity of an assembly line, in such a way that the material being used in the production runs through the measurement gap 30. Data is then measured in the measurement gap 30, using one or more of the above presented methods, whereby a set of parameters is extracted 50. The set of parameters is related to the properties of the measured part of the product 90 being tested, for example the thickness and/or the dielectric loss. The parameters are evaluated using an algorithm 60, and a signal may be emitted when the parameters do not lie within a predetermined interval of acceptance. Such a signal is preferably handled by an electronic front end 70, which comprises a suitable alarm device 80, giving for example an audible and/or visible alarm signal that can be observed by a user and/or a person supervising the process.

An exemplary mechanical setup, illustrating the arrangement 20 of the sensor consists in a mounting plate 21, used for connecting the sensor to the production machine. The arrangement further comprises an electronic compartment with a lower lid 22 and an upper lid 23. The lower and upper lids 22, 23 form the measurement gap 30, in which measurement capacitors (to be described below) are accommodated.

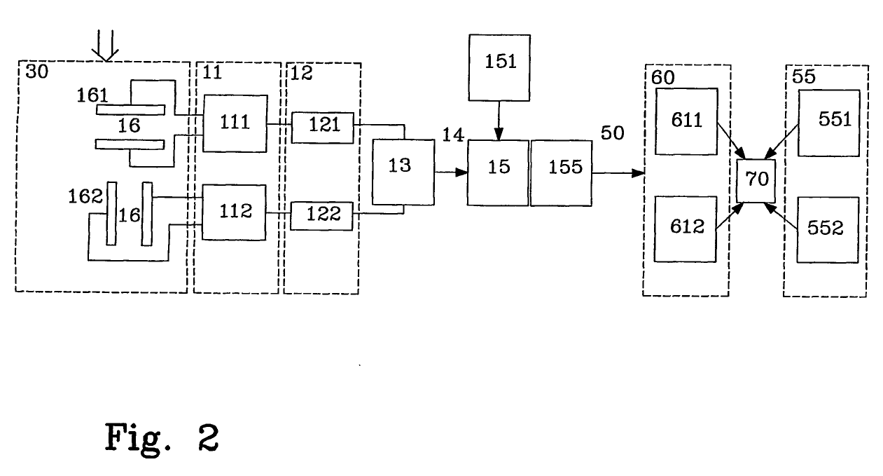

Now with reference to FIG. 2, an electronic apparatus 10 is shown more in detail comprising at least two oscillators, one being a measurement oscillator 111 and the other being a reference oscillator 112. In a preferred embodiment of the present invention two oscillators are used, giving an economic and easy to handle electronic apparatus 10. The frequencies of the respective oscillators 111, 112 are determined by a set of miniature capacitor plates 16 being suitably placed in the measurement gap 30. The measurement oscillator 111 derives its frequency from the measurement capacitor 161, and the reference oscillator 112 from the reference capacitor 162. The measurement capacitor 161, and reference capacitor 162 constitute a measurement zone, but it is to be noted that the measurement zone does not necessarily comprise capacitors. In alternative embodiments inductors may be used, or antenna elements or other suitable means. In the following, however, capacitors are used for illustrating the principles of the present invention.

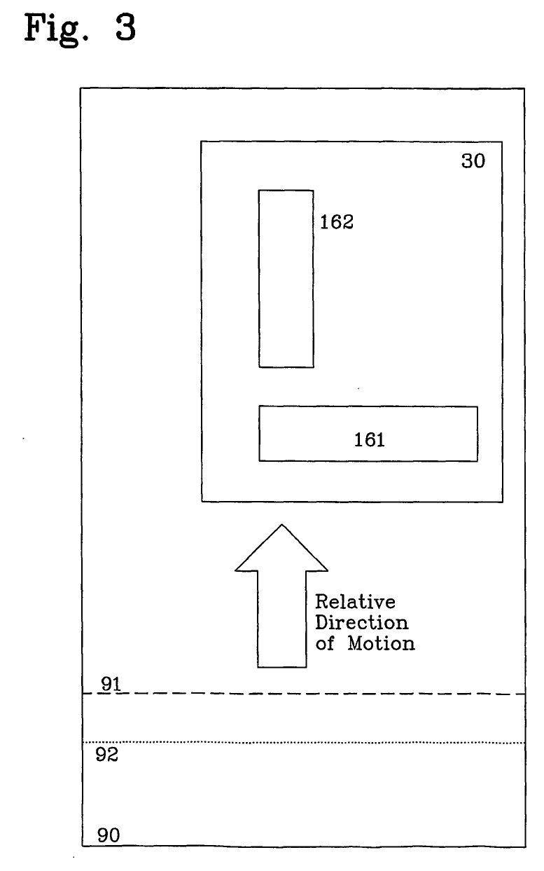

When the present invention is used in detecting features of a material running in an assembly line, for example in the manufacture of plastic bags, the geometrical form of the capacitors has to be carefully considered. In the case of plastic bags manufacture, the geometrical form of the measurement capacitor 161 is chosen to be parallel to the expected placement of the weldings 92 and perforations 91 of the product 90 being tested. The reference capacitor 162 is chosen to be arranged orthogonal to the measurement capacitor 161, and thus being parallel to the direction of motion of the material being tested, see FIG. 3. Using this structure, the reference capacitors 162 have a much smaller area than the measurement capacitors 161 through which the material passes, and are thus affected less by material changes than are the measurement capacitors 161. Further, by this structure, long range variations in the thickness, temperature and other microwave properties of the product are eliminated, since both oscillator frequencies are influenced in the same way. Other arrangements of the oscillators 111, 112 and/or the capacitors 161, 162 are of course possible.

The oscillator outputs 12 are the measurement RF signal 121 and a reference RF signal 122, and they are down converted using a microwave mixer 13. The down conversion is preferably performed in order to more readily be able to perform the required calculations, since the used frequencies are so high that variations of the frequencies would be hard to detect without a down conversion. The difference frequency between the oscillators 111, 112, being the difference between the down converted measurement RF signal 121 and the down converted reference RF signal 122, is available on the IF output 14 of the mixer 13. However, in an alternative embodiment of the present invention, a direct difference signal may be conceivable, without any down conversion step. As an additional feature of the present invention, the frequency of the signal travelling on this line may be counted using a high speed counter 15, for example realised by emitter coupled logic (ECL) or microwave frequency divider followed by digital counter, by comparing it to a frequency normal 151. The result of the frequency measurement is available in a measurement latch 155 for further processing, and may for example be used in order to calculate the number of plastic bags passing through the measurement gap 30.

The measurement signal(s) is proportional to short range variations in the thickness of the product being tested. The oscillation frequency is more specifically proportional to the capacitance difference of the measurement oscillator 111 and the reference oscillator 112. Perforations 91 constitute a reduction of the amount of material present in the measurement gap 30, and weldings 92 constitute a removal of material out of the welding groove as a result of the welding process. Therefore, perforations 91 and weldings 92 of the material passing by the sensor arrangement will be visible as a reduction of the capacitance of the measurement capacitor 161, whereas the reference capacitor 162 remains at first hand unchanged by its different choice of geometry. These differences in the capacitance consequently enable the innovative way of detecting properties of the material being tested.

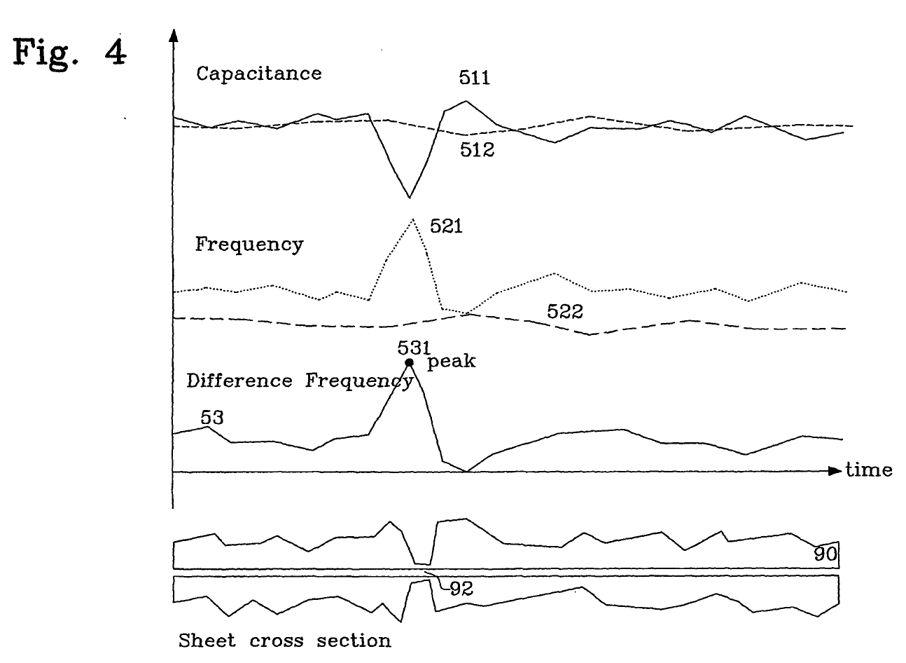

In FIG. 4, a time curve of the measurement capacitor value 511, and a time curve of the reference capacitor value 512 are shown in the upper part of the figure. Curve 511 corresponds to the detection of the welding 92, and the reference capacitor time function 512 remains approximately unchanged by its different choice of geometry. A reduction in capacitance results in an increased oscillation frequency of the measurement oscillator 111, as can be seen in 521 in FIG. 4, whereas the reference oscillator frequency 522 remains unchanged. Choosing a correct sideband in the mixer IF signal results in the difference frequency 53 exhibiting an upwards peak 531 in time as a consequence of a welding (or a perforation) passing by the measurement gap 30. FIG. 4 shows time evolution of the capacitance and the detected signal frequency upon a welding (or perforation) of the material passing through a measurement gap.

With reference again to FIG. 2, the peak 531 in the difference signal is collected in a welding peak bin 611 and a perforation peak bin 612, respectively, and is compared to an interval of acceptance for the weldings 551 and perforations 552, respectively. The limit values of intervals of acceptance for said signals may be programmed from the machine environment via the front end 70, thus rendering it easy and convenient for the user to change intervals in accordance with different requirements. In case of the peak signal being at some point outside said respective intervals of acceptance, a suitable signal may be given, triggering an alarm device 80 (see FIG. 1). The signal may then be communicated to a user by forwarding it to the machine environment by the front end 70, in the form of an audible alarm and/or a visible alarm (such as a blinking lamp or the like), alerting a user.

In the description above, the measurement and supervision of transverse weldings of a material is illustrated. However, in an alternative embodiment, the longitudinal weldings of a material may be supervised in a similar fashion.

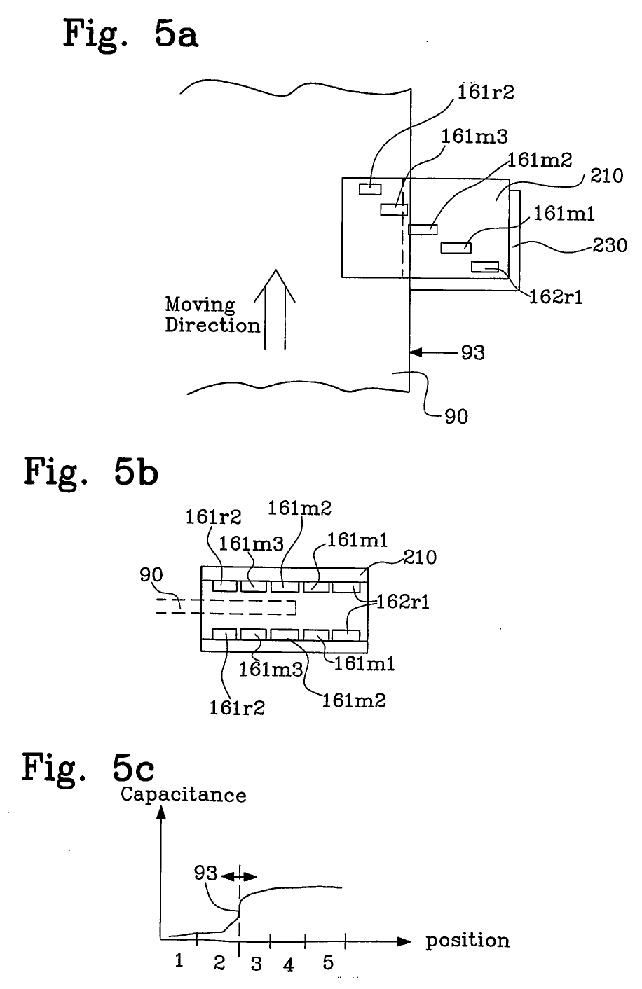

In FIG. 5a an alternative embodiment of the present invention is shown. In some instances there is a need to know where, in relation to the production machine, the material is located. For example, in the production of plastic bags, it may be desirable to know the position of the plastic film used. To this end, the present invention may be used in the shown arrangement. FIG. 5a shows a view from above, with the product 90 being tested. An arrangement 210, 230 is positioned above and beneath the product 90 being tested, the arrangement comprising at least one reference capacitor 162r1 positioned outside the edge 93 of the material and at least one reference capacitor 162r2 located such that said material passes the measurement zone of the reference capacitor 162r2, and at least two measurement capacitors 161m1-161m3. In the figures three measurement capacitors are shown, but it is realised that a greater or fewer number of components may be used in accordance with the requirements of a specific application. FIG. 5b shows a longitudinal view of the arrangement shown in FIG. 5a, with the product 90 outlined with a dashed line. The edge 93 of the product 90 being tested may in some applications be moving a bit laterally back and forth. This is especially common in applications such as for example when needing to position the warp in a warp-knotting machine, or the like. In accordance with the invention, one of the capacitors is used as a reference capacitor 162r1 always being positioned outside the edge 93 of the product 90, and one of the capacitors is used as a reference capacitor 162r2 always being positioned inside the edge 93 of the product 90. The other capacitors are used as measurement capacitors 161m1-161m3. If the product 90 moves sideways the capacitance between the different measurement capacitors 161m1-161m3 changes, and the edge 93 of the product may be located, as is schematically illustrated in FIG. 5c. When the product 90 moves laterally, the edge 93 may be detected by means of the capacitance of the capacitors (denoted 1-5 in FIG. 5c). The more measurement capacitors 161m1-161m3, the more accurately the position may be determined, but in the simplest embodiment only two measurement capacitors are needed. The signal being detected may be connected to some mechanical adjustment means, in order to move the product 90 accordingly. If the product 90 moves too far at either side, a warning signal may be sent alerting the user of this, enabling him to take action, for example temporarily stopping the production for correcting the position of the material.

Further, it is conceivable to use only measurement oscillators, if

$$\frac{\partial ω}{\partial t}$$

is used as the measurement signal, where ω is the oscillator frequency and t is the time.

In summary, the present invention is based on the idea of obtaining reference values and measurement values more or less simultaneously, preferably using microwave radiation for determining various characteristics and features of different materials, such as plastics. In short, three different methods are presented: 1) frequency domain measurement, where a transmitted microwave radiation is analysed; 2) time domain measurement, where a reflected microwave radiation is analysed; and 3) microwave reaction, where an oscillator is used and the frequency and signal strength of which is analysed.

1. System for determining characteristics of a material, characterised in that said system comprises means for continuously acquiring at least one reference value, and means for acquiring at least one measurement value, said reference value and said measurement value being acquired essentially simultaneously and compared in real-time, whereby characteristics of said material (90) may be determined.

2. System as claimed in claim 1, wherein said system comprises a plurality of means for acquiring a reference value and/or a plurality of means for acquiring a measurement value.

3. System as claimed in claim 1 or 2, characterised in that at least one of said means for acquiring a reference value is arranged such that said material is arranged to move and/or pass in a measurement zone of said means.

4. System as claimed in any of the claims 1-3, characterised in that at least one of said means for acquiring a measurement value is arranged such that said material is arranged to move and/or pass in a measurement zone of said means.

5. System as claimed in any of the claims 1-4, wherein each of said means for acquiring a reference value is a reference sensor, and wherein each of said means for acquiring a measurement value is a measurement sensor.

6. System as claimed in claim 5, wherein at least one of said measurement sensors and at least one of said reference sensor are spaced apart in the direction of movement of moving and/or passing material.

7. System as claimed in any of the claims 5-6, wherein a measurement zone of at least one of said measurement sensors and a measurement zone of at least one of said reference sensors are spaced apart in a direction transversal to the direction of movement of moving and/or passing material.

8. System as claimed in any of the claims 5-7, wherein a measurement zone of at least one of said measurement sensors and a measurement zone of at least one of said reference sensors have different geometry in the direction of moving and/or passing material.

9. System as claimed in any of the claims 1-8, wherein said system comprises means for sending and measuring microwave radiation, whereby said microwave radiation is used in determining said characteristics of the material (90).

10. System as claimed in claim 9, wherein said means for sending and measuring microwave radiation comprises means for measuring a microwave transmission factor (S21) between two ports, between which said material is arranged to run.

11. System as claimed in claim 10, wherein said means for measuring comprises means for calculating the ratio between power received by one of said ports and power emitted by the other of said ports.

12. System as claimed in claim 11, wherein the effective thickness (d) of said material is determined by calibration data, and the following equations:
$$\begin{matrix}{k}_{0} = ω \cdot \sqrt{{ɛ}_{0} \cdot {μ}_{0}} & [ 1 ] \\ k = ω \cdot \sqrt{{ɛ}_{r} \cdot {ɛ}_{0} \cdot {μ}_{r} \cdot {μ}_{0}} & [ 2 ] \\ {S}_{21} = {e}^{= i kd } \cdot {e}^{- i {k}_{0} ( D - d )} & [ 3 ] \\ d = \frac{{k}_{0} D - i \cdot log {S}_{21}}{( k - {k}_{0} )} & [ 4 ]\end{matrix}$$
where ε=dielectric constant of the material, ε₀=dielectric constant of vacuum, k=wave vector in the material, k₀=wave vector in vacuum, μ=permeability and μ₀=permeability of vacuum, d=thickness of the material, D=the distance between the transmit and the receive ports.

13. System as claimed in any of claims 9-12, wherein said means for sending and measuring microwave radiation comprises at least two oscillators (111, 112), and at least two independent measurement zones coupled to said oscillators (111, 112).

14. System as claimed in claim 13, wherein each measurement zone comprises capacitor plates (161, 162) determining an oscillation frequency of an oscillator (111, 112) in the microwave range.

15. System as claimed in claim 1, wherein said means for acquiring reference value(s) and measurement value(s) comprises at least two measurement zones, whereby each measurement zone comprises inductors or antenna elements.

16. System as claimed in claim 1, wherein means are included for measuring the oscillation frequency of an oscillator circuit, said oscillator circuit using properties of said material, in order to deduce properties of said material.

17. System as claimed in any of the preceding claims, wherein said characteristics comprise one of more of the following: the thickness of the material, the dielectric loss of the material, perforations in the material, weldings in the material.

18. Method for determining characteristics of a material characterised in that said method comprises the steps of continuously acquiring at least one reference value, and acquiring at least one measurement value, said reference value and said measurement value being acquired essentially simultaneously and compared in real-time, whereby characteristics of said material (90) may be determined.

19. Method as claimed in claim 18, wherein said method comprises the step of acquiring a plurality of reference values by a plurality of means for acquiring a reference value and/or acquiring a plurality of measurement values by a plurality of means for acquiring a measurement value.

20. Method as claimed in claim 18 or 19, wherein said material moves and/or passes in a measurement zone of at least one of said means for acquiring a reference value.

21. Method as claimed in any of the claims 18-20, wherein said material moves and/or passes in a measurement zone of at least one of said means for acquiring a measurement value.

22. Method as claimed in any of the claims 18-21, wherein each of said means for acquiring a reference value is a reference sensor, and wherein each of said means for acquiring a measurement value is a measurement sensor.

23. Method as claimed in claim 22, wherein at least one of said measurement sensors and at least one of said reference sensor are spaced apart in the direction of movement of said moving and/or passing material.

24. Method as claimed in any of the claims 22-23, wherein at a measurement zone of least one of said measurement sensors and a measurement zone of at least one of said reference sensors are spaced apart in a direction transversal to the direction of movement of said moving and/or passing material.

25. Method as claimed in any of the claims 22-24, wherein a measurement zone of at least one of said measurement sensors and a measurement zone of at least one of said reference sensors have different geometry in the direction of said moving and/or passing material.

26. Method as claimed in claim 18, that said method comprises the step of sending and measuring microwave radiation, whereby said microwave radiation is used in determining said characteristics of the material (90).

27. Method as claimed in claim 26, wherein said step of sending and measuring microwave radiation comprises the step of measuring a microwave transmission factor (S21) between two ports, between which said material runs.

28. Method as claimed in claim 27, wherein said step of measuring comprises the step of calculating the ratio between power received by one of said ports and power emitted by the other of said ports.

29. Method as claimed in claim 28, wherein the effective thickness (d) of said material is determined by calibration data, and by using the following equations:
$$\begin{matrix}{k}_{0} = ω \cdot \sqrt{{ɛ}_{0} \cdot {μ}_{0}} & [ 1 ] \\ k = ω \cdot \sqrt{{ɛ}_{r} \cdot {ɛ}_{0} \cdot {μ}_{r} \cdot {μ}_{0}} & [ 2 ] \\ {S}_{21} = {e}^{= i kd } \cdot {e}^{- i {k}_{0} ( D - d )} & [ 3 ] \\ d = \frac{{k}_{0} D - i \cdot log {S}_{21}}{( k - {k}_{0} )} & [ 4 ]\end{matrix}$$
where ε=dielectric constant of the material, ε₀=dielectric constant of vacuum, k=wave vector in the material, k₀=wave vector in vacuum, μ=permeability and μ₀=permeability of vacuum, d=thickness of the material, D=the distance between the transmit and the receive ports.

30. Method as claimed in any of claims 18-29, wherein said step of sending and measuring microwave radiation comprises using at least two oscillators (111, 112), and at least two independent measurement zones coupled to said oscillators (111, 112).

31. Method as claimed in claim 18, wherein said step of acquiring reference value(s) and measurement value(s) comprises using at least two measurement zones, wherein each measurement zone comprises capacitor plates (161, 162) determining an oscillation frequency of an oscillator (111, 112) in the microwave range.

32. Method as claimed in claim 29, wherein each measurement zone comprises inductors or antenna elements.

33. Method as claimed in claim 18, wherein a step is included in which properties of said material is deduced by measuring the oscillation frequency of an oscillator circuit, said oscillator circuit using properties, such as the thickness or the dielectric loss, of said material.

34. Method as claimed in any of claims 18-33, wherein said characteristics comprise one of more of the following: the thickness of the material, the dielectric loss of the material, perforations in the material, weldings in the material.

35. Method as claimed in claim 18, wherein said step of determining the characteristics and features of a material (90) is accomplished by arranging at least two measurement zones (161, 162) on opposing sides of the material (90), at least one of said measurement zones (161) measuring small range changes of a characteristic of said material (90).

36. Method as claimed in claim 34, wherein at least one of said measurement zones (162) is arranged to detect long range changes of a characteristic of said material (90).
